(19) United States
(12) Patent Application Publication
(10) Pub. No.: US 2019/0120421 A1
(43) Pub. Date: Apr. 25, 2019

(54) RESERVE TANK MOUNTING STRUCTURE

(71) Applicants: HONDA MOTOR CO., LTD., MINATO-KU, TOKYO (JP); AUTOLIV NISSIN BRAKE SYSTEMS JAPAN CO., LTD., UEDA-SHI,NAGANO (JP)

(72) Inventors: Takaaki OHNISHI, WAKO-SHI, SAITAMA (JP); Hikaru YADORI, WAKO-SHI, SAITAMA (JP); Hirotaka HIRANO, WAKO-SHI, SAITAMA (JP); Sekihei SHIMOZONO, UEDA-SHI, NAGANO (JP)

(21) Appl. No.: 15/758,998

(22) PCT Filed: Sep. 9, 2016
(86) PCT No.: PCT/JP2016/076704

§ 371 Date: Mar. 9, 2018

(30) Foreign Application Priority Data
Sep. 11, 2015 (JP) 2015-179263

(51) Int. Cl. F16M 13/02; B60T 17/06

(52) U.S. Cl. CPC F16M 13/02; B60T 11/26; B60T 17/06

(57) ABSTRACT

An object of the present invention is to provide a reserve tank mounting structure capable of absorbing displacement of a reserve tank to disperse a load caused by vibration of a vehicle. A bracket includes front and rear fastening points for fixing a reserve tank by bolt members from a vertical direction, corresponding to front and rear mounting arms projecting in a vehicle width direction from positions spaced apart from each other in a vehicle longitudinal direction with a cap opening therebetween. In a state where the reserve tank is fixed to a vehicle body, the cap opening is disposed between the fastening points.

### TECHNICAL FIELD

The present invention relates to a reserve tank mounting structure.

### BACKGROUND ART

A conventional reserve tank mounting structure for storing, for example brake fluid, is a structure in which a metal bracket is fixed to an engine compartment inner wall of a vehicle, and a mounting piece extending from the reserve tank is fastened to the bracket by a bolt member (hereinafter also referred to as a fastening member). Thus, the reserve tank is fixed in a state of being suspended from a cantilever-like bracket (see, for example, Patent Document 1).

### CITATION LIST

### Patent Literature

Patent Document 1: Japanese Patent Application Publication No. 2014-008815

### SUMMARY OF INVENTION

### Technical Problem

However, in the conventional reserve tank mounting structure, the mounting piece extends from a peripheral edge of a cap opening of the reserve tank, that is, from a base end. Therefore, a load applied to the reserve tank due to vibration of the vehicle or the like is concentrated in a small area around the cap opening. An object of the present invention is to provide a reserve tank mounting structure capable of dispersing a load caused by vibration of the vehicle.

### Solution to Problem

A reserve tank mounting structure of the present invention includes a reserve tank with a cap opening formed in an upper surface thereof, and a bracket for holding the reserve tank on a vehicle body side, wherein a plurality of support portions respectively extend outwardly in a vehicle width direction from positions spaced apart from each other in a vehicle longitudinal direction with the cap opening therebetween on the upper surface of the reserve tank, and the bracket includes a seat surface facing a side surface of the reserve tank, fastening points for fastening the support portions are respectively formed at intervals in the vehicle longitudinal direction in the seat surface, and the cap opening is disposed between the fastening points. According to the present invention, the load caused by the vibration of the vehicle or the like applied to the reserve tank is transmitted to the seat surface forming the fastening points through the support portions respectively extending outwardly in the vehicle width direction. The load can be dispersed in a plane by the support portions without being concentrated in a small area in the upper surface of the reserve tank. Further, the reserve tank is integrally provided with displacement restricting ribs below the support portions, and the displacement restricting rib has a contact surface opposed to a side edge of the seat surface of the bracket. Since the displacement restricting rib contacts the side edge of the seat surface of the bracket, the reserve tank is prevented from oscillation around the fastening point.

### Advantageous Effects of Invention

According to the present invention, it is possible to provide a reserve tank mounting structure capable of dispersing the load caused by vibration of the vehicle.

### BRIEF DESCRIPTION OF DRAWINGS

FIG. 1 is a schematic perspective view of an engine compartment showing a reserve tank mounting structure of a vehicle;

FIG. 2 is an enlarged perspective view of a main portion of a reserve tank mounting structure of a comparative example;

FIG. 3 is a perspective view showing a state in which a reserve tank is fixed to a bracket in the reserve tank mounting structure according to an embodiment of the present invention;

FIG. 4 is a side view showing a positional relationship between the reserve tank and a master cylinder connected through a pipe in the reserve tank mounting structure according to the embodiment of the present invention;

FIG. 5 is a top view showing the positional relationship between the reserve tank and the master cylinder connected through the pipe in the reserve tank mounting structure according to the embodiment of the present invention;

FIG. 6 is a perspective view showing the positional relationship between the reserve tank and the master cylinder connected through the pipe in the reserve tank mounting structure according to the embodiment of the present invention;

FIG. 7 is a front view as seen from the front of the vehicle, showing the positional relationship between the reserve tank and the master cylinder connected through the pipe in the reserve tank mounting structure according to the embodiment of the present invention;

FIG. 8 is a perspective view of a lower portion of a reserve tank body in the reserve tank mounting structure according to the embodiment of the present invention; and

FIG. 9 is an enlarged perspective view of the reserve tank viewed from an arrow C in FIG. 8 in the reserve tank mounting structure according to the embodiment of the present invention.

### DESCRIPTION OF EMBODIMENTS

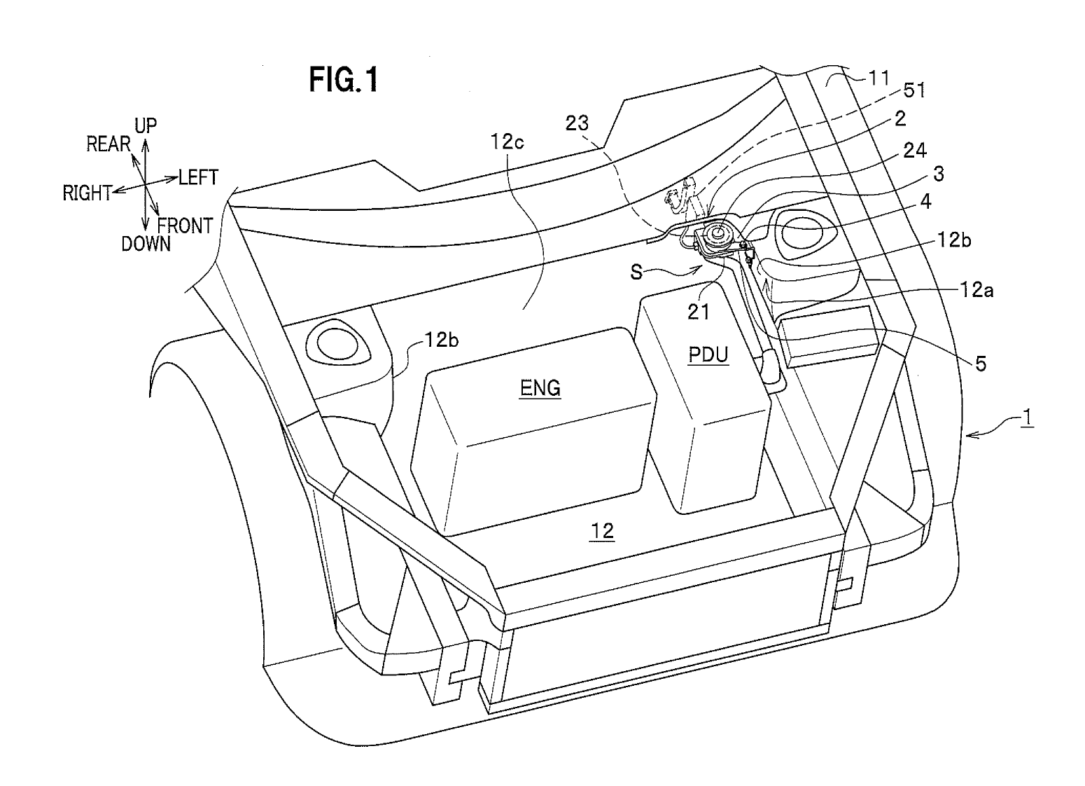

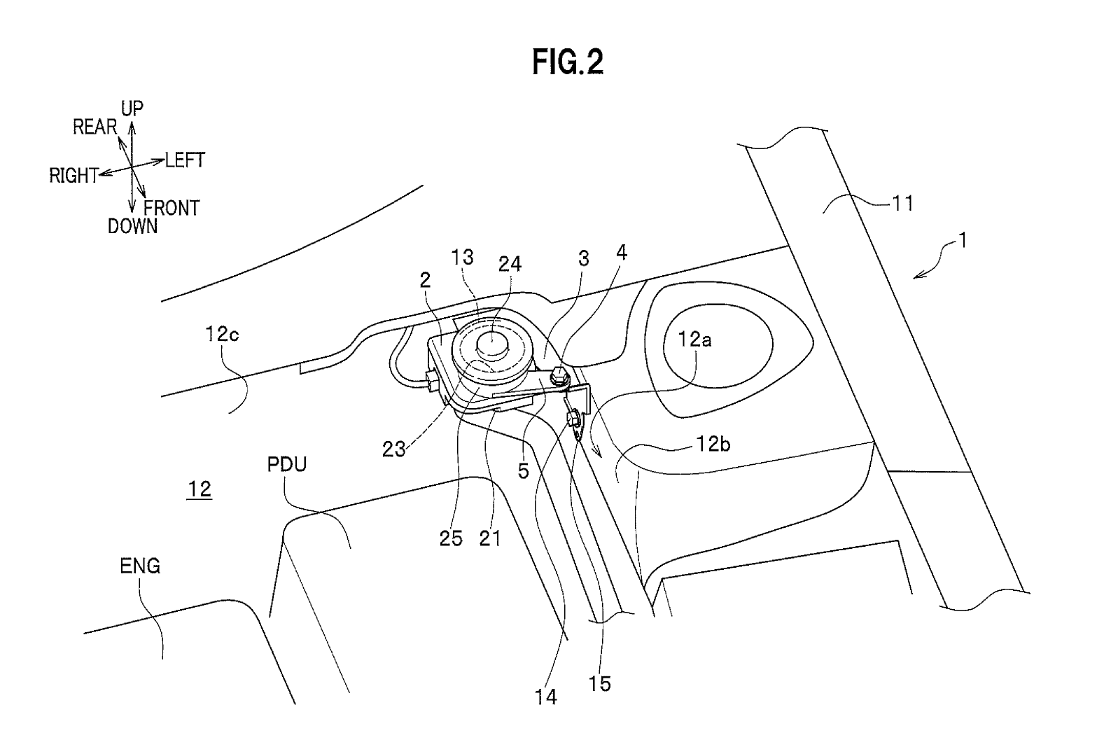

Hereinafter, an embodiment of the present invention will be described with reference to the drawings. FIG. 1 is a schematic perspective view of an engine compartment showing a reserve tank mounting structure of a vehicle 1. FIG. 2 is an enlarged perspective view of a main portion of the reserve tank mounting structure shown as a comparative example.

### [Configuration of Vehicle Body]

As shown in FIG. 1, a vehicle body 11 mainly includes a skeleton frame and a panel body forming a skeleton of the vehicle 1. In the vehicle body 11, an engine compartment 12 with an upper opening opened or closed by a hood (not shown) is formed in front of a vehicle compartment.

The engine compartment 12 is a space for housing an engine ENG, a motor (not shown), a power drive unit PDU (Power Drive Unit) and the like, and is formed in a hollow shape including an engine compartment inner wall 12a constituting an interior thereof and a hood (not shown). Auxiliary machines, which are peripheral devices required to drive the vehicle 1 by driving the engine ENG, are arranged in the engine compartment 12. Note that both the engine ENG and the motor may be arranged in the engine compartment 12, or the engine compartment 12 may be a motor compartment in which only the motor is disposed.

The engine compartment inner wall 12a is a mounted portion on which a metal mounting bracket 3 is mounted, for example, in this comparative example. The engine compartment inner wall 12a is formed to have left and right side walls 12b, 12b in the engine compartment 12, a partition wall 12c partitioning the engine compartment 12 from the vehicle compartment, a front grill forming a front wall of the engine compartment 12, and the like.

The side walls 12b, 12b are formed to have a metal panel material such as a wheel housing fixed to a pair of left and right side members (not shown) and a damper housing. Further, the partition wall 12c is formed by connecting a metal panel material such as a dash panel to a cross member disposed perpendicular to the left and right side members.

### [Configuration of Reserve Tank]

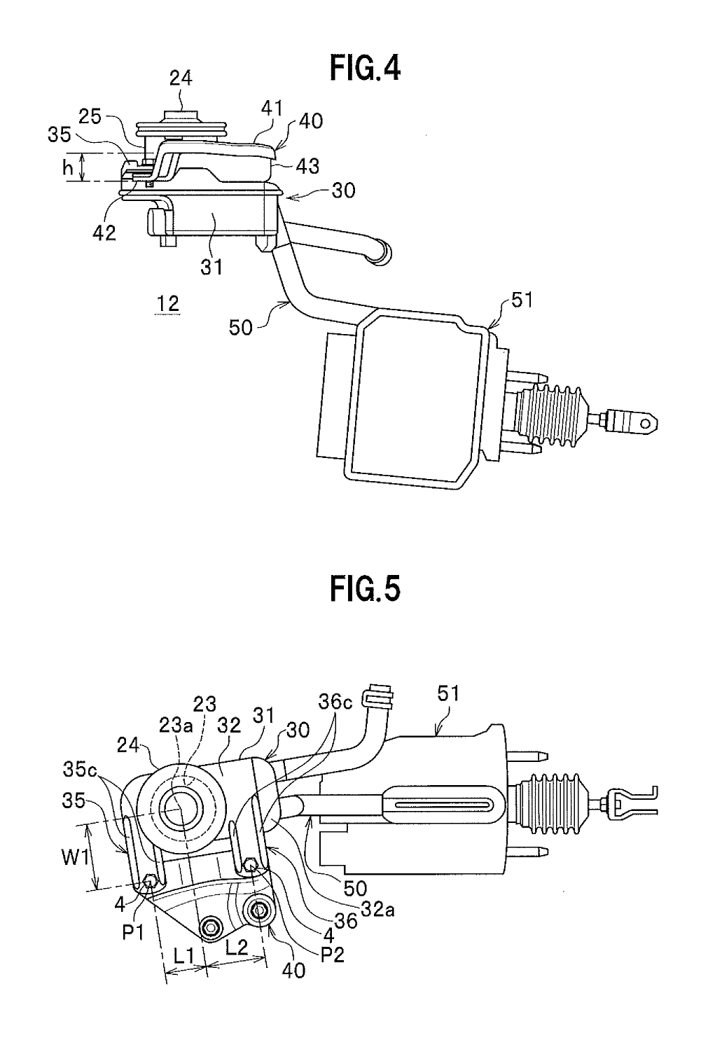

A reserve tank 2 is a tank for storing, for example, brake fluid (hydraulic oil) used for brakes. The reserve tank 2 mainly includes a resin tank body 21 and a resin cap 24 for closing a cap opening 23 opened and formed in an upper portion of the tank body 21. The reservoir tank 2 is disposed at a position higher than a master cylinder 51 (see FIG. 4 described below) in the engine compartment 12 in order to prevent suction of air when the brake fluid is supplied to the master cylinder 51 as its supply destination.

### COMPARATIVE EXAMPLE

FIG. 2 is an enlarged perspective view of the main portion of the reserve tank mounting structure shown as the comparative example. In this comparative example, a mounting piece 5 is integrally projected from the reserve tank 2 outwardly in a vehicle width direction (in this case, toward the side wall 12b of the wheel housing). The mounting piece 5 projects from the cap opening 23 formed on an upper surface of the tank body 21 with a peripheral edge of a cylindrical portion 25 as a base end.

Meanwhile, on the side wall 12b of the wheel housing or a strut portion constituting the engine compartment inner wall 12a, the metal mounting bracket 3 having a substantially L-shape when viewed from the side is fixed by aligning a bolt member 14 and a pin member 15, for example, in a vehicle vertical direction. In a state where the mounting piece 5 is superimposed on an upper surface of the mounting bracket 3 and bolt holes are aligned, a bolt member 4 is, for example, inserted through from a vehicle upper side to a lower side to be fastened and fixed.

Further, an arc-shaped support portion 13 is integrally formed in the mounting bracket 3 of this comparative example. In a mounted state of the reserve tank 2, the reserve tank 2 is cantilevered and suspended from the mounting bracket 3, and a side surface of the cylindrical portion 25 is brought into contact with the support portion 13 to prevent rotation.

In support structure of the reserve tank 2 of this comparative example, an entire weight of the tank body 21 is supported by the cylindrical portion 25 formed on a peripheral edge of the cap opening 23.

Therefore, when a position of the reserve tank 2 is displaced in the vehicle vertical direction by vibration of the vehicle 1, a load is concentrated in a point of the cap opening 23 as a center.

### [Mounting Structure of Reserve Tank]

Therefore, in the reserve tank mounting structure of the present embodiment, it is intended to absorb displacement of a reserve tank 30 to disperse the load generated by the vibration of the vehicle 1.

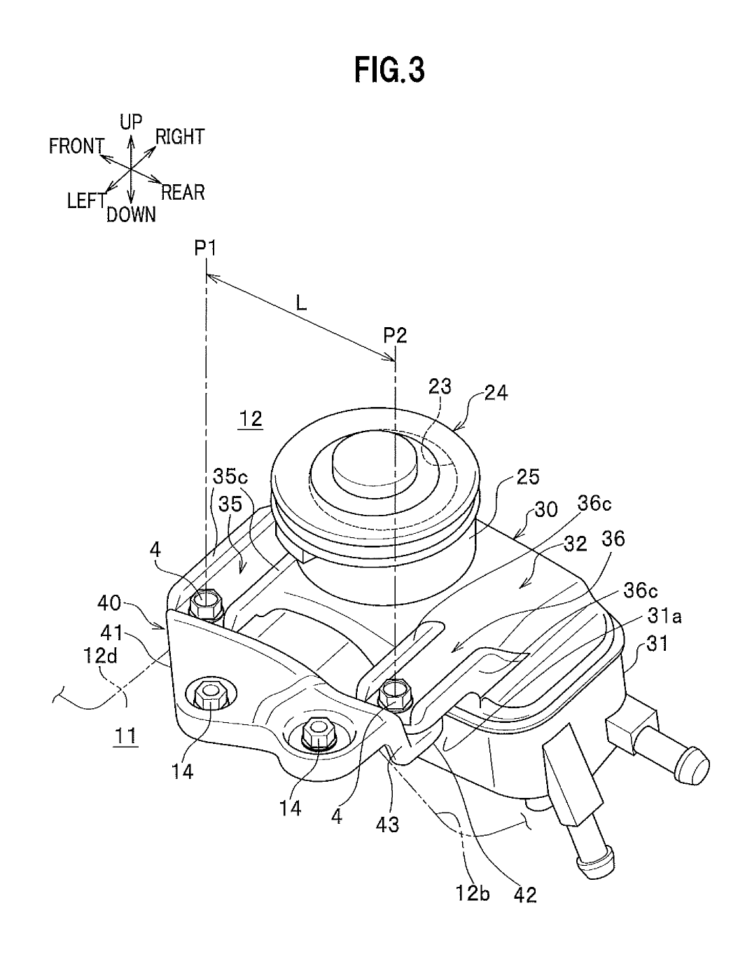

Specifically, as shown in FIG. 3, the reserve tank 30 and a resin bracket 40 provided on the vehicle body 11 side are fixed by a pair of fastening members (bolt members) 4, 4. Then, the cap opening portion 23 is disposed to be positioned between bolt hole positions (fastening points P1, P2) through which the bolt members 4, 4 are inserted in a vehicle longitudinal direction.

The reserve tank 30 has a tank body 31 made of a resin container integrated by joining a plurality of cases such as upper and lower cases. A pair of front and rear mounting arms 35, 36 as support portions is integrally provided on an upper surface 32 of the tank body 31. In this embodiment, the front and rear mounting arms 35, 36 are provided on the upper surface 32 by integral molding, but they may be integrally formed, for example, by joining.

The front and rear mounting arms 35, 36 of this embodiment are positioned spaced apart from each other with the cap opening 23 therebetween in a front view of the reserve tank 30 (when viewed from a side of the vehicle). As shown in FIG. 3, when the reserve tank 30 is mounted on the vehicle body 11, base ends of the front and rear mounting arms 35, 36 are integrally connected to positions spaced apart from each other in the vehicle longitudinal direction with the cap opening 23 therebetween.

The front and rear mounting arms 35, 36 respectively have a pair of upward ribs 35c, 35c and a pair of upward ribs 36c, 36c, and have a substantially concave cross-sectional shape perpendicular to their longitudinal direction. Ends of the front and rear mounting arms 35, 36 extend in parallel with each other outwardly in the vehicle width direction (toward the side wall 12b of the strut portion on which the bracket 40 is mounted in the drawing).

Bolt holes (not shown) for inserting the bolt members 4, 4 are opened and formed in vicinities of distal ends of the front and rear mounting arms 35, 36. The fastening points P1, P2 corresponding to center positions of these bolt holes are spaced apart from each other with a predetermined dimension L in the vehicle longitudinal direction.

Meanwhile, the bracket 40 is formed of a resin material and includes a vehicle body side fixing portion 41 fixed to an upper surface 12d of the strut portion by bolt members 14, 14, a seat surface 42 formed at a lower position in the vehicle vertical direction than the vehicle body side fixing portion 41, and a vertical wall 43 integrally connecting the vehicle body side fixing portion 41 and the seat surface 42.

Among them, the seat surface 42 extends inwardly in the vehicle width direction toward a side surface 31a of the reserve tank 30. Bolt holes corresponding to the bolt holes at the ends of the front and rear mounting arms 35, 36 are formed spaced apart from each other with the predetermined dimension L in the vehicle longitudinal direction in the seat surface 42.

The seat surface 42 of this embodiment has a saddle-shaped cross-section in the vehicle longitudinal direction to improve rigidity in a bending direction, and the bolt holes are opened and formed in a position lower by one step in the seat surface 42.

When the reserve tank 30 is mounted on the vehicle body 11, the bolt holes of the seat surface 42 and the bolt holes at the ends of the front and rear mounting arms 35, 36 are aligned in the vehicle vertical direction. Then, the bolt members 4, 4 are respectively inserted into the bolt holes in a vehicle down direction, and are respectively screwed to nut members (not shown) on a back side of the bracket 40.

The ends of the front and rear mounting arms 35, 36 of the reserve tank 30 are respectively fastened by the bolt members 4, 4 to be fixed to the seat surface 42 of the bracket 40.

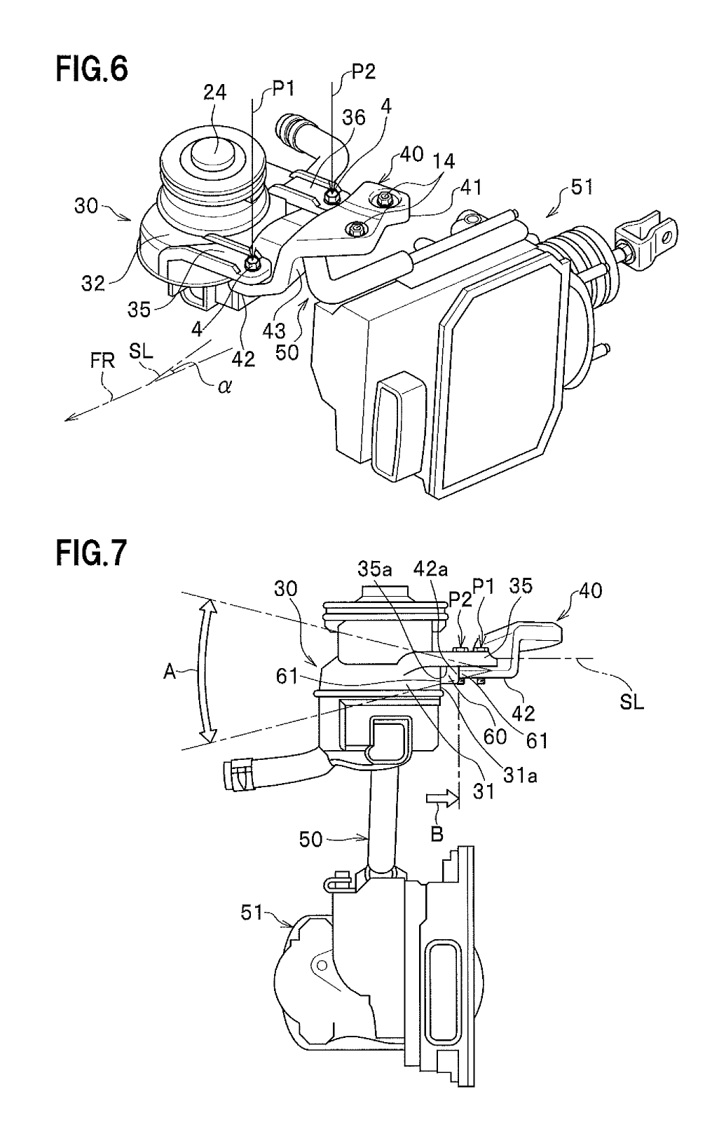

FIGS. 4 to 7 show a positional relationship between the reserve tank mounting structure of the present embodiment and the master cylinder 51 connected through a pipe 50, when the reserve tank mounting structure is applied to the vehicle. FIG. 4 is a side view, FIG. 5 is a top view, FIG. 6 is a perspective view, and FIG. 7 is a front view as seen from the front of the vehicle.

The reserve tank mounting structure of the present embodiment shown in FIG. 4 explains a height relationship when the reserve tank 30 is fastened and fixed to the bracket 40. The bolt holes formed in the seat surface 42 of the bracket 40 of this embodiment is formed in a lower position than the vehicle body side fixing portion 41 by a predetermined height h (see FIG. 4) in the vehicle vertical direction, while the seat surface 42 has a saddle-shaped cross-section.

Thus, when the reserve tank 30 is mounted so that the ends of the front and rear mounting arms 35, 36 are fastened to the seat surface portion 42, an upper end position of the cap 24 can be lowered by the predetermined height h. Therefore, it is possible to improve space efficiency in the engine compartment 12 by reducing a projecting dimension of the cap 24 in an upward direction.

As shown in FIG. 5, in the reserve tank 30 of the present embodiment, a center 23a of the cap opening 23 provided in the upper surface 32 is located between the fastening points P1, P2 of the front and rear mounting arms 35, 36 in the vehicle longitudinal direction.

In this embodiment, in a vehicle longitudinal direction dimension, the fastening point P1 is provided at a position spaced apart from the center 23a of the cap opening 23a by a predetermined distance L1 in a vehicle front direction, and the fastening point P2 is provided at a position apart from the center 23a of the cap opening 23a by a predetermined distance L2 in a vehicle rear direction.

Thus, forming positions in the upper surface portion 32 of the front and rear mounting arms 35, 36 can be set such that the vehicle longitudinal direction dimension is larger than that of a case where the forming positions are equally provided (L1×2<L1+L2), that is, a position of the rear mounting arm 36 is set such that the dimension L2 is larger than the dimension L1 and the position of the rear mounting arm 36 is close to a side edge 32a of the upper surface 32 of the tank body 31.

More specifically, the position of the rear mounting arm 36 is set such that the dimension L2 is expanded in the vehicle rear direction (L2>L1) as compared with a case where the forming positions are equally provided (L1=L2), and thus it is possible to further disperse the load to improve support rigidity.

Therefore, in the present embodiment, it is possible to set the fastening point P2 further away from the fastening point P1 and at a position closer to the side edge 32a of the upper surface 32. The base ends of the front and rear mounting arms 35, 36 are respectively arranged at positions spaced apart from each other in the vehicle longitudinal direction with the cap opening 23 of the upper surface 32 therebetween. Thus, substantially entire surface of the upper surface 32 is connected in a plane so that the load is not concentrated in a specific portion.

For example, when a dimension W1 from the center 23a to the fastening points P1, P2 is small, the fastening points P1, P2 are located within a range of the upper surface 32 or close to the cap opening 23 in a top view in the drawing, and thus there is a possibility that a stress is concentrated in a specific area.

Thus, it is possible to improve rigidity in a surface inward/outward direction of the upper surface 32 and to support the reserve tank 30 by dispersing the load applied to the surface. Specifically, in the present embodiment, the dimensions L1, L2 up to the fastening points P1, P2 are unequally expanded to the vehicle longitudinal direction (L2>L1).

Therefore, front and rear wall surfaces of the tank body 31 which is more rigid than the planar upper surface 32, and the base ends of the front and rear mounting arms 35, 36 can be arranged to be easily connected to each other. Thus, rigidity of a connecting portion can be further improved.

Therefore, it is possible to disperse a weight of the tank body 31 without concentrating the load on a specific portion unlike the cap opening 23 of the comparative example.

Further, since positions of the fastening points P1, P2 are separated by a relatively large distance (L1+L2) in the vehicle longitudinal direction, the reserve tank 30 does not easily oscillate in a pitching direction due to the vibration of the vehicle 1. Since two fastening points are provided, the reserve tank 30 does not move in a yawing direction (rotating direction in a horizontal plane around a vehicle vertical axis) as compared with a case where there is only one fastening point.

In the reserve tank 30 of the present embodiment shown in FIG. 6, a straight line SL connecting the fastening points P1 and P2 has a predetermined angle α with a vehicle center line (not shown) extending in a vehicle longitudinal direction FR. Further, the fastening points P1, P2 are fastened with a height difference in the vehicle vertical direction from mounting positions using the bolt members 14, 14 on the vehicle body side. Therefore, even when the vehicle 1 vibrates in a rolling direction, the reserve tank 30 hardly oscillates around the straight line SL connecting the bolt members 4, 4.

Meanwhile, as shown in FIG. 7, the reserve tank 30 tries to oscillate in a direction indicated by an arrow A in the drawing about the straight line SL due to vertical vibration of the vehicle 1.

In the metal mounting bracket 3 and the mounting piece 5 of the comparative example shown in FIG. 2, the vibration in the vehicle vertical direction of the reserve tank 30 is a bending moment acting in a perpendicular direction to the surface of the reserve tank 30. Therefore, when the bolt member 4 fastened to the mounting piece 5 is spaced outwardly in the vehicle width direction from the center 23a of the cap opening 23, oscillation may be further increased.

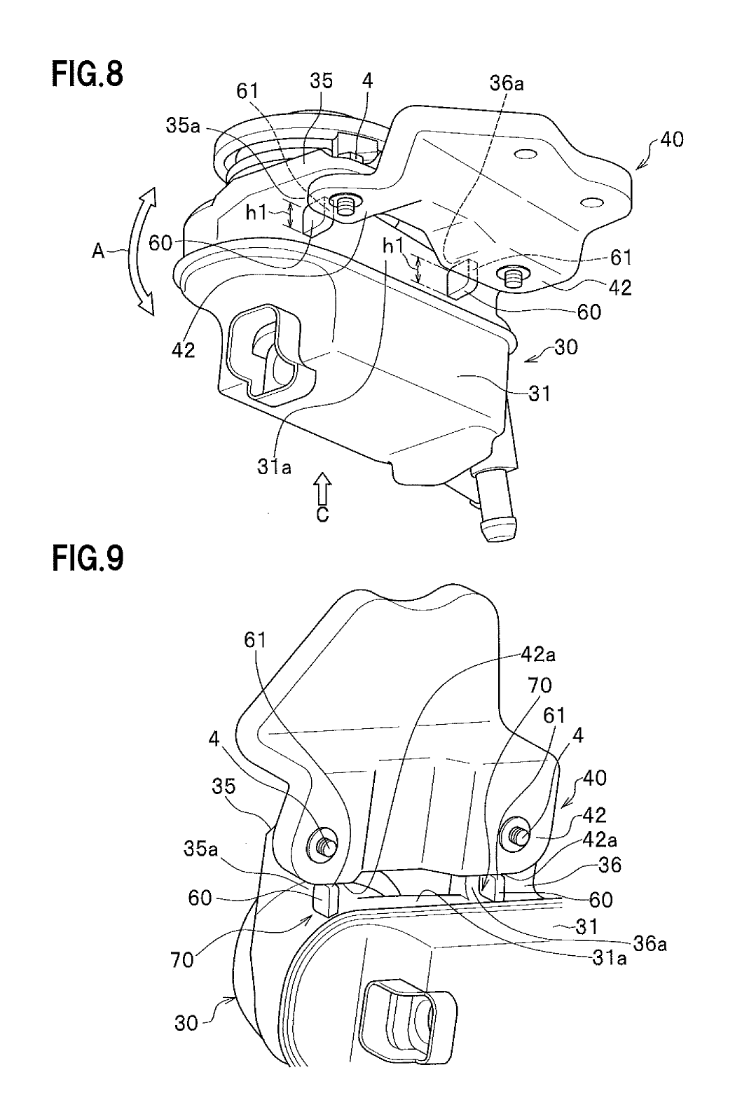

Therefore, in the reserve tank mounting structure of the present embodiment, in order to restrict oscillation of the reserve tank 30 around the straight line SL connecting the bolt members 4, 4 at the fastening points P1, P2 shown in FIG. 7, displacement restricting ribs 60, 60 (see FIGS. 8, 9 described later) are integrally provided respectively below the front and rear mounting arms 35, 36.

The displacement restricting ribs 60, 60 are connected to two surfaces of the side surface 31a of the tank body 31 of the reserve tank 30 and the lower surfaces 35a, 36a of the front and rear mounting arms 35, 36, so as to be sandwiched by the two surfaces substantially perpendicular to each other.

The displacement restricting ribs 60, 60 of the reserve tank mounting structure of the present embodiment have contact surfaces 61, 61 at positions facing a side edge 42a (see FIG. 9 described below) of the seat surface 42 of the bracket 40.

For example, when the reserve tank 30 tries to oscillate in the direction indicated by the arrow A in FIG. 7 or FIG. 8, the contact surfaces 61, 61 contact the side edge 42a of the seat surface 42, and thus it is possible to stop the displacement of the reserve tank 30 in the direction indicated by the arrow A.

FIGS. 8 and 9 are perspective views for describing positions of the displacement restricting ribs of the present embodiment. Among them, FIG. 8 is an enlarged perspective view for describing the displacement restricting ribs of the present embodiment. For example, a pair of displacement restricting ribs 60, 60 of the present embodiment are provided at positions facing the side edge 42a of the seat surface 42 and spaced apart from each other in the vehicle longitudinal direction so as to correspond to the bolt members 4, 4.

The resin bracket 40 can easily receive the load from the displacement restricting ribs 60 in a wide area by setting the side edge 42a of the seat surface 42 to a predetermined thickness direction dimension.

Meanwhile, the displacement restricting ribs 60, 60 are connected to the lower surfaces 35a, 36a of the front and rear mounting arms 35, 36 and the side surface 31a of the tank body 31 of the reserve tank 30, and are integrally formed with the tank body 31 at two surfaces. The contact surfaces 61, 61 have a predetermined height dimension h1 so that a sufficient pressure receiving area can be obtained depending on the predetermined thickness direction dimension in the side edge 42a.

Thus, the displacement restricting ribs 60, 60 can expand an area connected to the tank body 31 in proportion to an increase in the height dimension h1. Since the displacement restricting ribs 60, 60 are connected to the two surfaces of the side surface 31a and the lower surfaces 35a, 36a, it is possible to easily obtain desired rigidity required to prevent movement of the reserve tank 30 when the side edge 42a contacts the contact surfaces 61, 61 as compared with a configuration in which the displacement restricting ribs 60, 60 are connected to one surface of the lower surfaces 35a, 36a.

Further, the height dimension h1 is preferably equal to or greater than the thickness direction dimension of the side edge 42a of the seat surface 42 in order to obtain a sufficient displacement restriction effect. The displacement restricting ribs 60, 60 of this embodiment are hardly deformed in a falling direction as compared with displacement restricting ribs connected to only one surface of the lower surfaces 35a, 36a of the front and rear mounting arms 35, 36. Therefore, the contact surfaces 61, 61 of a desired height h1 can be set to the displacement restricting ribs 60, 60.

FIG. 9 is an enlarged perspective view of the reserve tank 30 viewed from an arrow C in FIG. 8 in the reserve tank mounting structure according to the present embodiment. In the present embodiment, even when the reserve tank 30 tries to oscillate in the direction indicated by the arrow A in FIG. 7, the side edge 42a of the seat surface 42 contacts the contact surfaces 61, 61. Thus, the reserve tank 30 is prevented from oscillating. Therefore, as shown in FIG. 5, the dimension W1 from the center 23a of the cap opening 23 to the positions of the fastening points P1, P2 can be largely spaced outwardly in the vehicle width direction.

The reserve tank 30 of the present embodiment avoids a concentration of the load caused by the vibration of the vehicle 1 and the base ends of the front and rear mounting arms 35, 36 are positioned on the upper surface portion 32, and thus rigidity to support the tank body 31 is improved. Therefore, it is preferable that the fastening points P1, P2 to which the load is applied are formed at the ends of the front and rear mounting arms 35, 36 extending outwardly in the vehicle width direction.

However, when the dimension W1 from the center 23a of the cap opening 23 to the positions of the fastening points P1, P2 is spaced outwardly in the vehicle width direction, and projecting dimensions of the front and rear side mounting arms 35, 36 are set long and the arms 35, 36 are cantilevered, the reserve tank 30 may move in the oscillation direction indicated by the arrow A in FIG. 7.

In contrast, in the present embodiment, even when the front and rear mounting arms 35, 36 are extended from the upper surface 32, since the displacement restricting ribs 60, 60 having a pair of contact surfaces 61, 61 contacting the side edges 42a, 42a of the seating surface 42 are provided, it is possible to prevent the movement of the reserve tank 30. Therefore, even when the front and rear mounting arms 35, 36 are extended from the upper surface 32, the load applied to the reserve tank 30 can be dispersed in a plane in the upper surface 32.

Further, the displacement restricting ribs 60, 60 of the present embodiment are connected to the lower surfaces 35a, 36a of the front and rear mounting arms 35, 36 and the side surface 31a of the tank body 31 of the reserve tank 30, and are connected to the tank body 31 at the two surfaces.

In this way, the displacement restricting ribs 60, 60 provided at inner corners 70, 70 where the lower surfaces 35a, 36a and the side surface 31a are perpendicular to each other connect the tank body 31 and the front and rear mounting arms 35, 36, so that the front and rear mounting arms 35, 36 are reinforced. Thus, the support rigidity of the front and rear mounting arms 35, 36 can be improved.

Therefore, sufficient supporting rigidity can be given to the front and rear mounting arms 35, 36 cantilevered and projecting outwardly in the vehicle width direction by a predetermined dimension W1 from the center 23a of the cap opening 23.

Further, the side edge 42a of the bracket 40 contacts the contact surface 61 of the displacement restricting rib 60 and stops the oscillation in the direction indicated by the arrow A in FIG. 7. Therefore, the bracket 40 does not interfere with the side surface 31a of the tank body 31. Further, the rigidity of the tank body 31 can be improved by integrally forming the displacement restricting rib 60 with the tank body 31.

Therefore, it is possible to improve damage resistance and further improve durability. It is more preferable that a position where the displacement restricting rib 60 is connected to the front and rear mounting arms 35, 36 coincides with at least one of the pair of upward ribs 35c, 36c shown in FIG. 3.

For example, positions of the displacement restricting ribs 60, 60 formed under the front and rear mounting arms 35, 36 can be set to coincide with positions of the upward ribs 35c, 36c formed upwardly on the front and rear mounting arms 35, 36. Thus, the cross-sectional shape of the front and rear mounting arms 35, 36 can be a substantial H-shape having a larger bending stress in the vehicle vertical direction than the concave cross-sectional shape.

Therefore, it is possible to further improve the rigidity of the front and rear mounting arms 35, 36, thereby restricting oscillation of the reserve tank 30 in the vehicle vertical direction.

Further, as shown in FIG. 3, the upward ribs 35c, 35c and 36c, 36c can be easily extended in the vehicle width direction along a surface extending direction of the upper surface 32. The load applied to the reserve tank 30 in the vehicle vertical direction is dispersed in a plane in the upper surface 32 by the upward ribs 35c, 36c.

In the present embodiment, the displacement restricting ribs 60, 60 can be respectively formed at positions that coincide with the positions of the upward ribs 35c, 35c and 36c, 36c in the vehicle vertical direction. Therefore, the support rigidity of the reserve tank 30 can be further improved.

### [Summary of Configuration and Effect]

As described above, according to the reserve tank mounting structure in the embodiment, the load generated by the vibration in the vertical direction of the vehicle body 11 is dispersed and absorbed in a plane in the upper surface 32.

The front and rear mounting arms 35, 36 formed apart from each other on the upper surface 32 do not concentrate the load in a small area around the cap opening 23. Further, even when the fastening points P1, P2 are spaced outwardly in the vehicle width direction from the center 23a of the cap opening 23 by the predetermined dimension W1, the oscillation around the straight line SL connecting the fastening points P1, P2 is prevented by the displacement restricting ribs 60, 60.

Therefore, the fastening points P1, P2 are spaced from the center 23a of the cap opening 23, and the load in the upper surface 32 is dispersed in a plane by connecting portions of the front and rear mounting arms 35, 36, so that stress concentration can be prevented.

### Modification

The present invention is not limited to the above-described embodiments, and various modifications can be made. The above-described embodiments are exemplified for easy understanding of the present invention, and are not necessarily limited to those having all components described above. Further, a part of components of one embodiment can be replaced by components of another embodiment, and components of another embodiment can be added to components of one embodiment. Furthermore, it is possible to delete a part of the components of each embodiment, or to add or replace other components. For example, modifications to the above embodiments can be as follows.

In the above embodiments, as shown in FIG. 7, a structure in which the displacement restricting ribs 60, 60 are provided in the reserve tank 30 has been described, however, the present invention is not limited to this. For example, the displacement restricting ribs 60, 60 may be provided on the bracket 40 side, and a shape, the number and a forming position of the displacement restricting ribs 60, 60 are not particularly limited.

### REFERENCE SIGNS LIST

1: vehicle
2, 30: reserve tank
3: mounting bracket
4: bolt member
5: mounting piece
11: vehicle body
12: engine compartment
12a: engine compartment inner wall
12b: side wall
12c: partition wall
12d: upper surface
13: support portion
14: bolt member
15: pin member
21, 31: tank body
23: cap opening
23a: center
24: cap
25: cylindrical portion
31a: side surface
32: upper surface
35, 36: front and rear mounting arms (support portions)
35a: lower surface
35c: rib
40: bracket
41: vehicle body side fixing portion
42: seat surface
42a: side edge
43: vertical wall
50: pipe
51: master cylinder
60: displacement restricting rib
61: contact surface
70: inner corner
P1, P2: fastening points
ENG: engine
PDU: power drive unit

1. A reserve tank mounting structure comprising:
a reserve tank with a cap opening formed in an upper surface thereof; and
a bracket for holding the reserve tank on a vehicle body side, wherein
a plurality of support portions respectively extend outwardly in a vehicle width direction from positions spaced apart from each other in a vehicle longitudinal direction with the cap opening therebetween on the upper surface of the reserve tank, and
the bracket comprises a seat surface facing a side surface of the reserve tank, fastening points for fastening the support portions are respectively formed at intervals in the vehicle longitudinal direction in the seat surface, and the cap opening is disposed between the fastening points.

2. The reserve tank mounting structure according to claim 1, wherein the reserve tank integrally has a displacement restricting rib below a mounting arm, and the displacement restricting rib has a contact surface opposed to a side edge of the seat surface.
